(19) United States
(12) Patent Application Publication
(10) Pub. No.: US 2021/0378410 A1
(43) Pub. Date: Dec. 9, 2021

(54) ACTUATOR SYSTEM

(71) Applicant: LINAK A/S, Nordbong (DK)

(72) Inventor: Lars Øgaard Svendsen, Sønderborg (DK)

(21) Appl. No.: 17/284,322

(22) PCT Filed: Oct. 25, 2019
(86) PCT No.: PCT/DK2019/000344

§ 371 Date: Apr. 9, 2021

(30) Foreign Application Priority Data
Oct. 25, 2018 (DK) PA 2018 00777

(51) Int. Cl. A47C 19/04; F16H 25/24; A47C 20/04

(52) U.S. Cl. CPC A47C 19/045; F16H 2025/2071; A47C 20/042; F16H 25/2454

(57) ABSTRACT

A linear actuator system for adjustable articles of furniture, including hospital beds, patient supports or the like, where a mechanical squeeze protection is provided by means of a mechanical coupling, and where a further improvement of the squeeze protection is provided by means of a controller monitoring the status of the coupling. The controller further comprises means for stopping and reversing the electric motor of the linear actuator, if the status of the coupling indicates a squeezing.

The present invention relates to an electrically driven linear actuator system comprising one or more electrically driven linear actuators and a squeeze protection in connection with such an actuator.

Electrically driven linear actuators are used in many different applications for adjusting the position of adjustable articles of furniture, including hospital beds, patient supports or the like. A common challenge when adjusting a piece of furniture either relative to the floor or relative to other parts of said piece of furniture is the risk of unintended squeezing of persons or objects.

Known methods for minimizing the risks of squeezing include safety guards or a protective construction of the adjustable piece of furniture for preventing persons or objects from entering into an unsafe area during the adjustment. A secure and protecting appearance and construction of the adjustable piece of furniture is an important safety measure, it is, however, not possible to eliminate all risks of squeezing by such measures.

Further, in the event of a squeezing, it is known to provide a threshold for the maximum force applied by the motor of the actuator during adjustment of the piece of furniture. This could e.g. be done by means of a mechanical coupling disengaging when a maximum force is exceeded.

An example of an electrically driven linear actuator with a mechanical anti-pinch protection is known from EP2699815 to DewertOkin GmbH, which describes a coupling able to ensure that the driving connection between a spindle nut and a connecting part can be decoupled in one direction at a relatively low torque.

EP1389355 to LINAK A/S describes a method for limiting the overload of a motor by monitoring the electric current drawn by the electrical motor of the electrically driven actuator and stopping the motor of the actuator in the event of an unusually high power-consumption or an unexpected increase in the power consumption. Thus, also achieving an anti-squeeze protection, since such an increase in the power consumption could indicate the occurrence of a squeezing.

A limitation of the force is an important safety measure, which can assist in the prevention of a dangerous situation in terms of squeezing. However, although the force is limited, a person or an object can still get caught and continuously squeezed and possibly as a result be injured or damaged.

Further, it is known to equip adjustable articles of furniture, including hospital beds, patient supports or the like with squeeze protection sensors. Such sensors can e.g. be light curtains or pressure/load sensors, which detect the presence of foreign objects already present in an unsafe area or entering an unsafe area during the adjustment. The signals of the sensors are transmitted to a control unit for the actuator system, which can then activate means for stopping the operation and/or setting off an alarm. Such squeeze protection sensors are e.g. known from EP2012731 to LINAK A/S.

A common challenge with squeeze protection sensors is that they only cover a limited area and are placed where a known risk of squeezing during a certain operation is present. However, for most articles of furniture and equipment it would be expensive and often practically impossible to equip all possibly unsafe areas with sensors for which reason only a few areas of potential squeezing risks are covered.

The object of the invention is to provide an electrically driven linear actuator system for adjustable articles of furniture, including hospital beds, patient supports or the like with an improved, safe and cost-efficient squeeze protection function.

The object is achieved by an actuator system comprising at least one linear electric actuator and a controller, where the at least one linear electric actuator comprises a reversible electric motor with a motor shaft, a transmission in engagement with the reversible electrical motor, a spindle and a spindle nut, where the spindle nut is arranged on the spindle, a coupling with a driving part in engagement with the transmission and a driven part in engagement with the spindle, the coupling being configured to be in a state of either
1) engaged, or
2) slipping or disengaged
   where the controller comprises at least one input for signals corresponding to a command for controlling the actuator system and at least one output for a control signal to the at least one linear actuator and/or for supplying electric power for driving the at least one linear electric actuator.

In an embodiment, the actuator system comprises means for monitoring the state of the coupling, where the controller is configured to set the state of the electric linear actuator to either;
3) an active state, where the rotation of the motor shaft is enabled, or an inactive state, where the rotation of the motor shaft is disabled.

Further, the controller is configured to receive a signal from the monitoring means indicating the state of the coupling and respond to the input from the monitoring means by setting the electric linear actuator in the active state, if the coupling is engaged, or the inactive state, if the coupling is slipping or disengaged.

It is thereby achieved that the actuator system will stop as soon as the monitoring means registers that the coupling is either slipping or disengaged, as this could indicate that an object is squeezed by an adjustable part of the piece of furniture or the like.

In an embodiment, the monitoring means comprises means for directly or indirectly detecting the rotation of the driving part and/or of the driven part of the coupling, where the controller has programmable means for comparing the signals indicating the rotation of the driving part or the rotation of the driven part of the coupling, respectively, and where the controller is configured to set the state of the electric linear actuator to an inactive state, if the programmable means indicate that the driven part and the driving part are rotating asynchronous to each other and thereby indicating that the coupling is slipping or disengaged.

In an embodiment, the means, which indirectly indicate the rotation on the driving part of the coupling, are means for monitoring the current drawn by the electrical motor.

Monitoring of the current drawn by the motor is a simple and cost-efficient way to indirectly monitor the rotation of the driving part.

In an embodiment, the means, which directly indicate the rotations of the driven part of the coupling, comprise a magnet engaging the driven part and a Hall sensor configured to detect the rotation of the magnet.

In an embodiment, the Hall sensor is a dual Hall sensor adapted to detect the rotation as well as the direction of rotation of the magnet.

The controller preferably comprises a micro controller with portions of program code to be executed, which serves the purpose of receiving and recording input signals and controlling the at least one actuator providing a drive signal and/or supply. The program code, parameters and measured values from sensors and calibration values are stored in a memory arranged with the micro controller.

In an embodiment, the controller further comprises programmable means, which, in the event that a signal from the monitoring means indicates that the coupling is slipping or disengaged while the electric motor is driven and the electric actuator as a result thereof has been set in the inactive state by the controller, are adapted to drive the electrical motor in the opposite direction for a predetermined number of rotations, a predetermined distance or for a predetermined period of time.

In an embodiment, the controller has means for activating an audible or visible alarm in the event that a signal from the monitoring means indicates that the coupling is slipping or disengaged.

In an embodiment, the controller is configured to control several similar actuators, which in parallel perform the same adjustment function. In the event that a coupling of any of the parallelly connected actuators is slipping or disengaged, all parallelly connected actuators will be set to the inactive state.

In an embodiment, the controller has programmable means configured to calculate the relative movement of the spindle nut based on the input from the rotation sensor. Additionally, the controller comprises a memory for storing preconfigured values or parameters and for storing values calculated by the controller. Further, the controller is adapted to store the latest calculated position of the spindle nut in case a signal from the monitoring means indicates that the coupling is slipping or disengaged.

In an embodiment, the controller is configured to block the re-activation of the electrical actuator, when a signal from the monitoring means indicates that the coupling is slipping or disengaged, until the operator has released and subsequently reactivated the input button of the control unit or the corresponding button on a remote-control unit, respectively, and/or upon activation of a special safety activation button and/or after a predetermined safety time has elapsed.

The coupling could be any type of mechanical coupling between two rotating shafts which can slip or disengage when a torque threshold is exceeded e.g. a friction coupling.

In an embodiment, the coupling is a ratchet coupling, where the coupling in one direction of rotation is in a state of engaged, and where the coupling in the opposite direction of rotation is either in the state of engaged or slipping or disengaged.

The linear actuator system according to the invention will be described more fully below with reference to the accompanying drawing, in which:

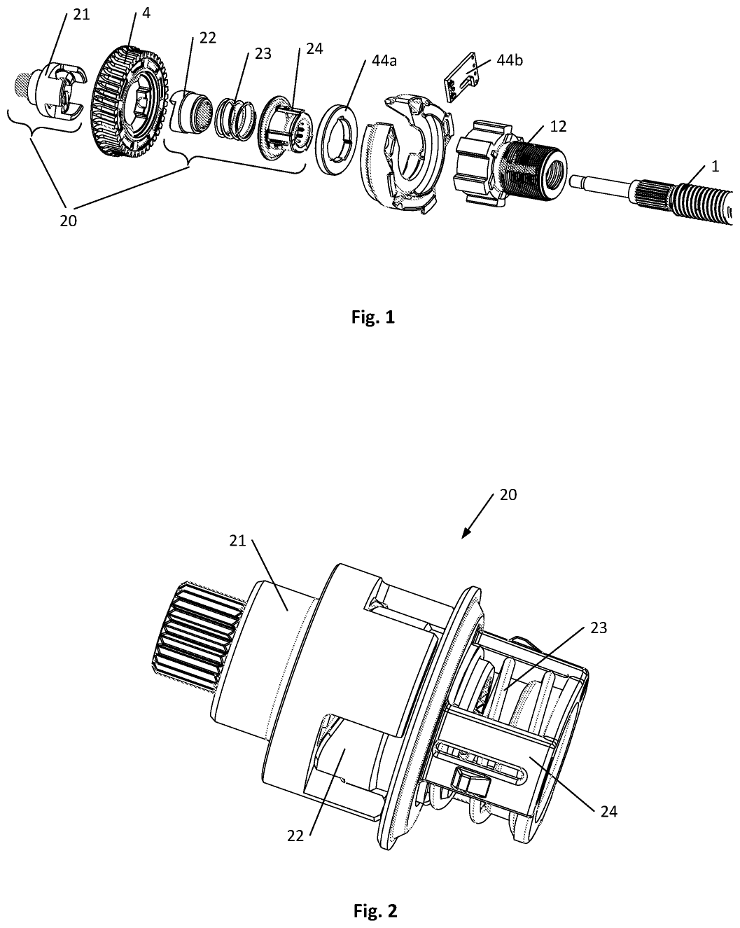

FIG. 1 shows an exploded view of a transmission and coupling of a linear actuator,

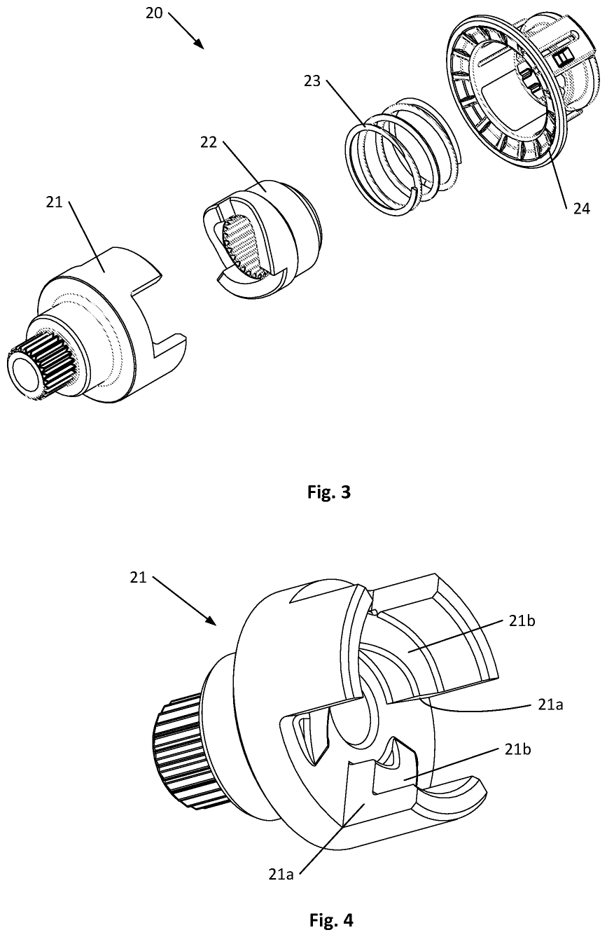

FIG. 2 shows the coupling of FIG. 1 in its assembled state,

FIG. 3 shows an exploded view of the coupling of FIG. 2,

FIG. 4 is a detailed view of the driving part of the coupling of FIG. 3,

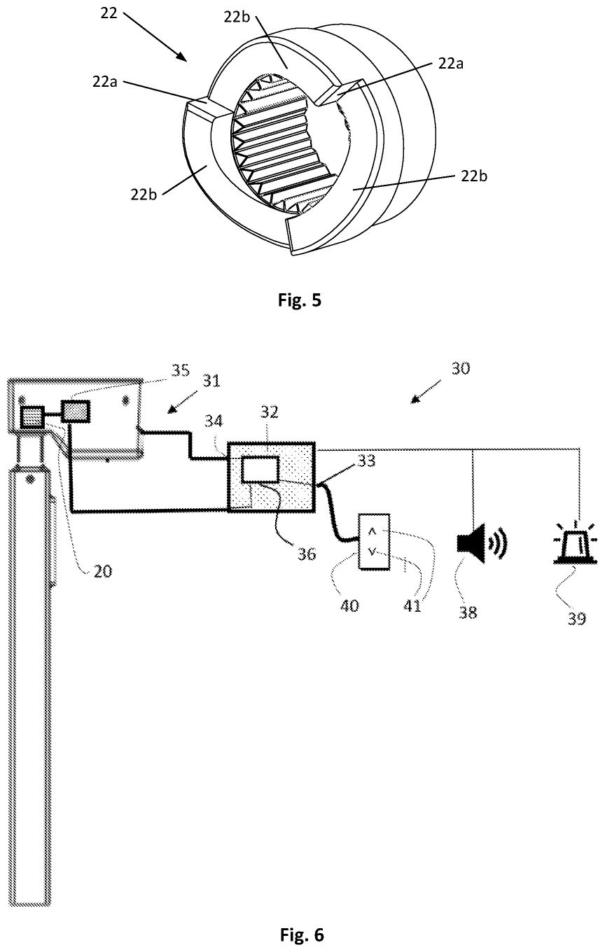

FIG. 5 is a detailed view of the driven part of the coupling of FIG. 3,

FIG. 6 shows a schematic build-up of an actuator system,

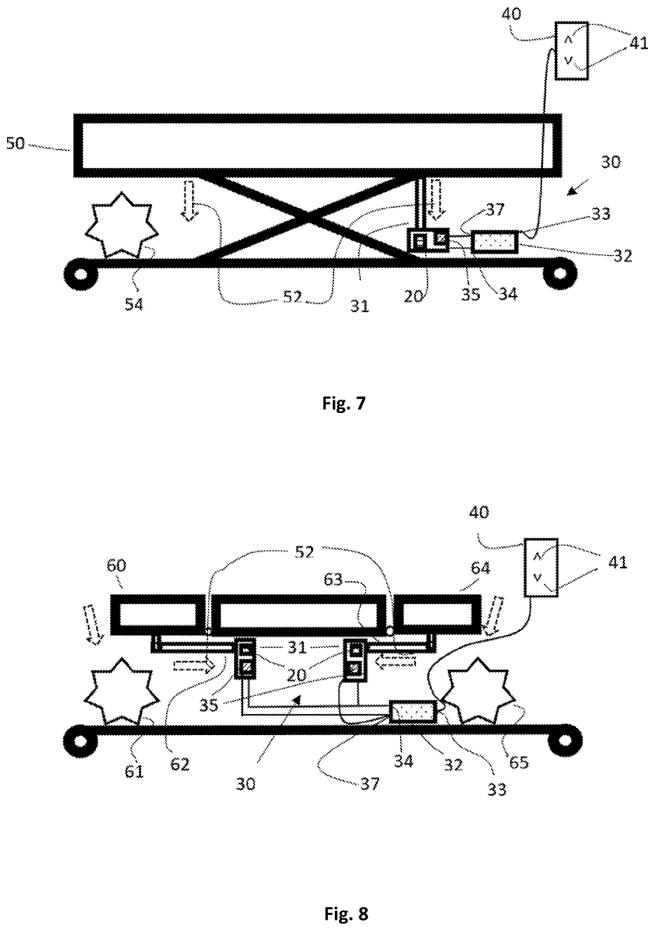

FIG. 7 shows an embodiment of a linear actuator system for an adjustable bedframe,

FIG. 8 shows an embodiment of a linear actuator system for a patient support with two tiltable sections,

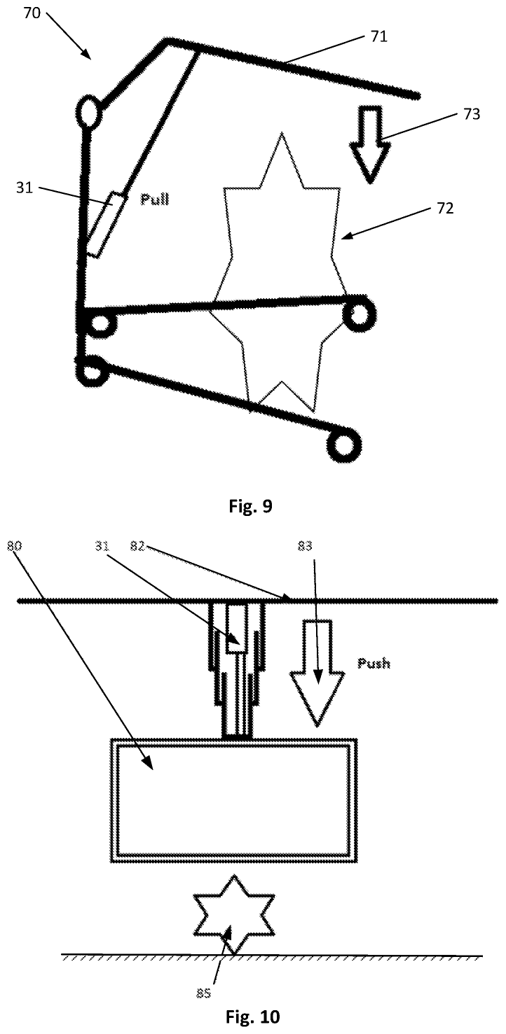

FIG. 9 shows an embodiment of a linear actuator system for a patient lifter,

FIG. 10 shows an embodiment of a linear actuator system for a height adjustable monitor,

FIG. 11 shows a basic flow chart of the logic functions within the controller,

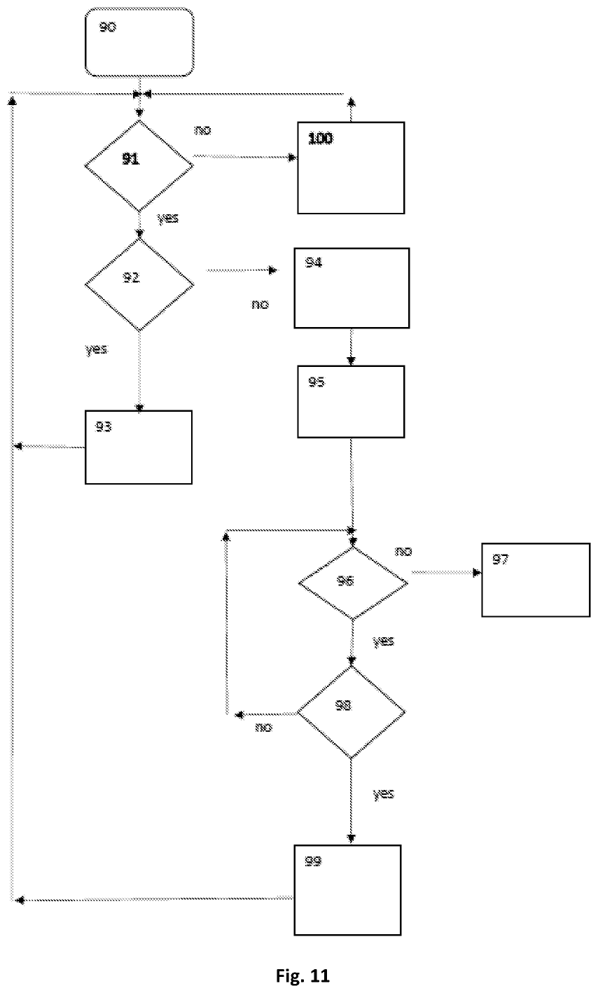

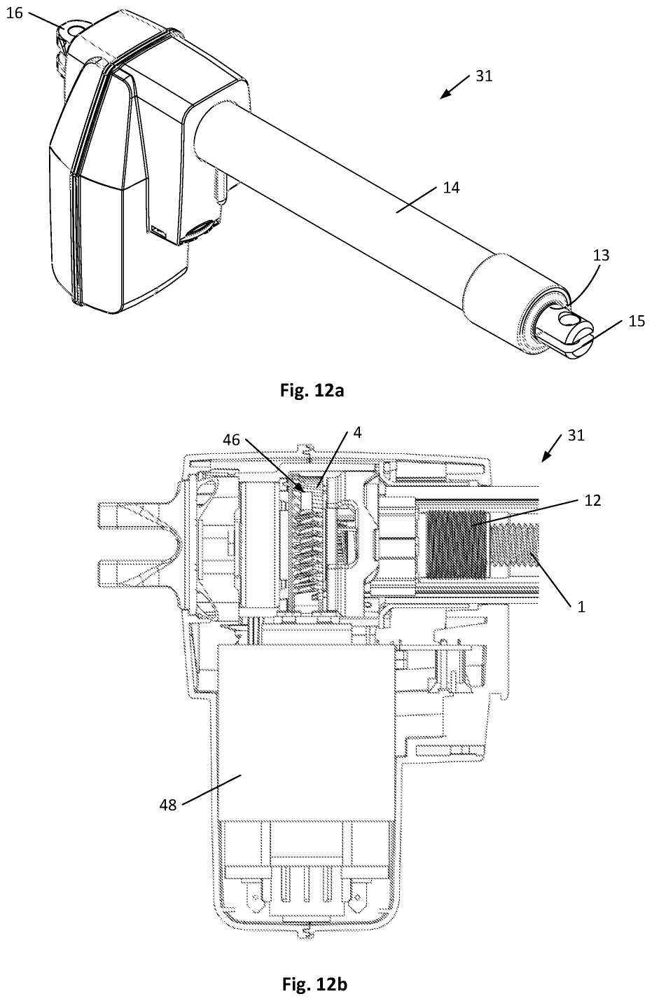

FIG. 12a shows an electric linear actuator, and

FIG. 12b shows a cross-section of an electric linear actuator.

FIG. 1 shows an exploded view of a coupling 20 between a worm wheel 4 and a spindle 1 of a linear actuator 31 (see FIGS. 12a and 12b). The worm wheel 4 is a part of a worm transmission 46 driven by an electrical motor 48 of the linear actuator 31.

The coupling 20 comprises a driving part 21 in engagement with the worm wheel 4 and a driven part 22, which via a spline connection is in engagement with the spindle 1. A coil spring 23 is at its one end supported by a spring holder 24. The other end of the coil spring 23 is pressing the driven part 22 against the driving part 21.

The spline connection allows for a limited axial movement of the driven part 22 relative to the driving part 21, thus allowing the coupling 20 to be in either the state of engaged or slipping or disengaged.

A spindle nut 12 is arranged on the spindle 1 and is connected to the inner tube 13 of the linear actuator 31 (see FIG. 12a). The inner tube 13 and the spindle nut 12 are secured against rotation. The rotation of the spindle 1 is transformed into an axial movement of the spindle nut 12 and the inner tube 13. The outer end of the inner tube 13 is connected to a front mounting 15.

FIG. 2 shows the coupling 20 with the driving part 21, the driven part 22, the coil spring 23 and the spring holder 24 in the assembled state. In this embodiment, the coupling 20 is a ratchet coupling.

FIG. 3 shows an exploded view of the coupling 20 of FIG. 2,

FIG. 4 is a detailed view of the driving part 21 of the coupling 20 of FIG. 2 and FIG. 3. The driving part 21 is equipped with three teeth extending in the axial direction. Each tooth has a first side 21a and a second side 21b. The surface of the first side 21a extends parallel to the axial direction of the driving part 21. The surface of the second side 21b extends at an angle of approximately 70-degrees relative to the axial direction of the driving part 21.

FIG. 5 is a detailed view of the driven part 22 of the coupling 20 of FIG. 2 and FIG. 3. The driven part 22 is equipped with three teeth extending in the axial direction. Each tooth has a first side 22a and a second side 22b. The surface of the first side 22a extends parallel to the axial direction of the driving part 21. The surface of the second side 22b extends at an angle of approximately 70 degrees relative to the axial direction of the driving part 21.

The ratchet coupling as illustrated in FIGS. 2-5 functions as follows:

The spring 23 pushes the driven part 22 against the driving part 21 such that the sides 21b engage the sides 22b.

When the driving part 21 is rotated clockwise, the first sides 21a of the driving part 21 are pushed against the first sides 22a of the driven part 22, whereby the driving part 21 rotates the driven part 22. This state corresponds to an engaged state of the coupling 20.

When the driving part 21 is rotated counter clockwise, the second sides 21b of the driving part 21 are pushed against the corresponding second sides 22b of the driven part 22. Due to the approximately 70-degree angle relative to the axial direction of the driving and driven part 21 and 22, respectively, the torque acting on the coupling 20 will have a resulting axial force component, which will push the driven part 22 in the axial direction against the force provided by the coil spring 23. If the torque on the coupling 20 during the counter clockwise rotation increases, the resulting axial force component will increase and eventually push the driven part 22 away from the driving part 21. At a certain level of torque (Tslip), the coupling 20 will start to slip and eventually be disengaged.

FIG. 6 is a schematic build-up of the actuator system showing an actuator system comprising a linear electric actuator 31 embodied as a lifting column and a controller 32. The lifting column 31 comprises essentially the same components as the electric linear actuator described above, i.e. a reversible electric motor with a motor shaft, a transmission in engagement with the reversible electrical motor, a spindle and a spindle nut, where the spindle nut is arranged on the spindle. A coupling 20 having a driving part 21 in engagement with the transmission and a driven part 22 in engagement with the spindle 1. The coupling 20 is either in the state fully engaged or slipping or disengaged.

The controller 32 comprises an input 33 for signals corresponding to a command for controlling the actuator system 30, an output 34 for a control signal for the linear actuator 31 and/or for supplying electric power for driving the linear electric actuator 31. The actuator system 30 comprises monitoring means 35 for monitoring the state of the coupling 20, the controller 32 is configured to set the state of the electric linear actuator 31 to either an active state, where the rotation of the motor shaft is enabled, or an inactive state, where the rotation of the motor shaft is disabled.

The controller 32 is configured to receive a signal from the monitoring means 35 indicating the state of the coupling 20, and if the coupling 20 is engaged set the electric linear actuator 31 to the active state, and if the coupling 20 is slipping or disengaged, set the state of the electric linear actuator 31 to the inactive state.

In the illustrated embodiment the controller 32 has programmable means 36 for comparing the signals indicating the rotation of the driving part 21 to the rotation of the driven part 22 of the coupling 20. The controller 32 has means for activating an audible alarm 38 or visible alarm 39 in the event that a signal from the monitoring means 35 is indicating that the coupling 20 is slipping or disengaged.

FIG. 7 shows an example of an application in which a linear actuator system 30 can be incorporated, said linear actuator system 30 is configured to lower a bed frame 50 by driving the linear actuator 31 in the pull direction 52. In this example, the linear actuator 31 is provided with a coupling 20, which at a certain torque (Tslip) is configured to be in a state of slipping or disengaged.

The coupling 20 could be a ratchet coupling (as illustrated in FIGS. 2 to 5), where the coupling 20 and a linear actuator 31 are arranged such that the counter clockwise rotation of the driving part 21 corresponds to the pull direction 52 of the linear actuator 31. The controller 32 has an input 33 for receiving a signal corresponding to a command from a user control unit 40. During a normal lowering of the bed frame, the torque on the coupling 20 will be lower than Tslip.

If the bed frame 50 hits an obstacle 54, the axial movement of the spindle nut 12 will be impeded, whereby the torque on the spindle and thereby the torque acting on the coupling 20 will increase. When the torque level Tslip is reached, the coupling 20 will be in the state of slipping or disengaged. The controller 32 is connected to monitoring means 35, which can register the state of the coupling 20, and the controller is configured to set the state of the electric actuator 31 to an inactive state when the rotation of the motor shaft is disabled due to the coupling 20 being in a state of slipping or disengaged.

In an embodiment of the illustrated actuator system, the controller 32 can further be configured to, after the electric linear actuator 31 has been set to the inactive state, to reactivate the motor and drive the linear actuator 31 in the opposite direction of the pull direction 52. Thus, automatically raising the bed frame 50 to a height, which provides a safe distance between the bed frame 50 and the obstacle 54.

In an embodiment of the illustrated actuator system, the controller 32 is configured to check the correct functioning of the monitoring means 35 and set the state of the electric actuator 31 to inactive if an incorrect functioning is detected. In an embodiment where the coupling 20 is a ratchet coupling, the checking of the monitoring function is done as follows: Since the coupling 20 will always be in the state of engaged while driven opposite the pull direction 52, the monitoring means 35 should, if functioning correctly, in this situation indicate that the coupling 20 is engaged. However, if the monitoring means 35 in this situation still indicate that the coupling 20 is in the state of slipping or disengaged, this would indicate an incorrect functioning of the monitoring system.

FIG. 8 shows an example of an application in which a linear actuator system according to the invention could be incorporated, where a first section 60 of a bed is tilted downwards by a first linear actuator 62 and a second section 64 of a bed is tilted downwards by a second linear actuator 63. The bed sections 60 and 64 are tilted downwards by driving the actuators 62 and 63 in the pull direction.

The basic construction of the actuator system is as described in FIG. 6 and FIG. 7, with the exception that the system comprises two actuators in engagement with the section 60 and section 64, respectively.

The controller 32 comprises an input 33 for signals corresponding to a command for controlling the actuator system 30, an output 34 for control signals for both linear actuators 31 and/or for supplying electric power for driving both linear electric actuators 31.

The actuator system 30 comprises monitoring means 35 for monitoring the state of the coupling 20 in each of the two linear actuators. The controller 32 is configured to set the state of one or both electric linear actuators 31 to either an active state, where the rotation of the motor shaft is enabled, or an inactive state, where the rotation of the motor shaft is disabled.

The controller 32 is configured to receive a signal from the monitoring means 35 indicating the state of each coupling 20 of the two linear actuators, and in case the coupling 20 is engaged, set the state of the respective electric linear actuator 31 to the active state, and in case the coupling 20 is slipping or disengaged, set the state of the respective electric linear actuator 31 to inactive.

FIG. 9 shows an example of an application in which the linear actuator system according to the invention can be incorporated, where a lift arm of a mobile patient lifter 70 is lowered by means of a linear actuator 31. The patient lifter arm 71 is lowered by driving the actuator 31 in the pull direction 73. The linear actuator is adapted to adjust the height of a patient lifter arm 71. The risk involved is that an object 72 can get squeezed by the lifting arm 71 when the lifting arm 71 is lowered by driving the actuator 31 in the pull direction 73. The linear actuator system for the patient lifter illustrated in FIG. 9 can be constructed as illustrated and described for the adjustable bed in FIG. 7

FIG. 10 shows an example of an application in which a linear actuator system 30 according to the invention can be incorporated, where an object 80, e.g. a monitor, can be lowered or raised from a ceiling 82 by means of a linear actuator 31. The object 80 is lowered by driving the linear actuator 31 in the push direction 83. The risk involved is that an object 85 can get squeezed by the monitor 80 when the monitor is lowered by driving the actuator 31 in the push direction 83. Therefore, the coupling 20 should be configured to be in the state of slipping or disengaged when the monitor 80 hits an object 85 during the lowering. The linear actuator system for the monitor as illustrated in FIG. 10 can be constructed as illustrated and described for the adjustable bed in FIG. 7.

FIG. 11 is a basic flow chart of the logic functions within the controller 32. The flow and the text in the boxes are as follows:

| | |
|---|---|
| 90 | Start |
| 91 | Control command for stated action present? |
| | If “yes” continue to 92, If “no” go to 100 |
| 92 | Monitoring means indicating coupling engaged? |
| | If “yes” continue to 93: If “no” go to 94 |
| 93 | Enter active state, continue stated action and go to 91 |
| 94 | Enter inactive state and go to 95 |
| 95 | Enter active state with opposite stated direction for |
| | predetermined back driving distance |
| 96 | Monitoring means indicating coupling engaged? |
| | If “no” go to 97. If “yes” go to 98 |
| 97 | Enter fatal error state, (system can only be reactivated by new |
| | start) |
| 98 | Predetermined back driving distance reached? |
| | If “no” go to 96. If “yes” go to 99 |
| 99 | Reset (neutralize) commands for stated action and go 91 |
| 100 | Enter inactive state and go to 91 |

FIG. 12a shows an electric linear actuator 31 having an inner tube 13 and an outer tube 14. The inner tube 13 is connected to a front mounting 15 for connection with a part of an adjustable piece of furniture. The actuator 31 further has a rear mounting 16 for connection with another part of the adjustable piece of furniture.

FIG. 12b shows a cross-section of an electric linear actuator 31, comprising an electric motor 48, a worm transmission 46, a worm wheel 4, a spindle 1, a spindle nut 12, an inner tube 13, an outer tube 14 and a rear mounting 16.

1. An actuator system (30) comprising at least one linear electric actuator (31) and a controller (32), where the at least one linear electric actuator (31) comprises:
a reversible electric motor with a motor shaft,
a transmission (46) in engagement with the reversible electric motor (48),
a spindle (1) and a spindle nut (12), where the spindle nut (12) is arranged on the spindle (1),
a coupling (20) with a driving part (21) in engagement with the transmission (46) and a driven part (22) in engagement with the spindle (1),
the coupling (20) being configured to be in a state of either
1) engaged, or
2) slipping or disengaged,
where the controller (32) comprises:
at least one input (33) for signals corresponding to a command for controlling the actuator system (30),
at least one output (34) for a control signal to the at least one linear electric actuator (31) or for supplying electric power for driving the at least one linear electric actuator (31),
wherein the actuator system (30) comprises means (35) for monitoring the state of the coupling (20),
where the controller (32) is configured to set the state of the electric linear actuator (31) to either
3) an active state, where the rotation of the motor shaft is enabled, or
4) an inactive state, where the rotation of the motor shaft is disabled,
where the controller (32) is configured to receive a signal from the monitoring means (35) indicating the state of the coupling (20) and respond to the input from the monitoring means (35) by setting the electric linear actuator (31) in
3) the active state, if the coupling (20) is 1) engaged, or
4) the inactive state, if the coupling (20) is 2) slipping or disengaged.

2. The actuator system according to claim 1 wherein
the monitoring means (35) comprises means for directly or indirectly detecting the rotation of the driving part (21) or of the driven part (22) of the coupling (20),
where the controller (32) has programmable means (36) for comparing the signals indicating the rotation of the driving part (21) or the rotation of the driven part (22) of the coupling (20), respectively, and
where the controller (32) is configured to set the state of the electric linear actuator (31) to an inactive state, if the programmable means (36) indicate that the driven part (21) and the driving part (22) are rotating asynchronous to each other and thereby indicating that the coupling (20) is slipping or disengaged.

3. The actuator system according to claim 2 wherein the means, which indirectly indicate the rotation on the driving part (21) of the coupling (20), are means for monitoring the current drawn by the electric motor.

4. The actuator system according to claim 2 wherein the means, which directly indicate the rotations of the driven part (22) of the coupling (20), comprise a magnet (44a) connected to the driven part (22) and a Hall sensor (44b) configured to detect the rotation of the magnet (44a).

5. The actuator system according to claim 4 wherein the Hall sensor (44b) is a dual Hall sensor adapted to detect the rotation as well as the direction of rotation of the magnet (44a).

6. The actuator system according to claim 1 wherein the controller (32) further comprises programmable means (36), which in the event that a signal from the monitoring means (35) indicates that the coupling (20) is slipping or disengaged while the electric motor is driven in a stated direction and the electric actuator (31) as a result thereof has been set in the inactive state by the controller (32), are adapted to drive the electric motor in the opposite direction for a predetermined number of rotations, a predetermined distance, or a predetermined period of time.

7. The actuator system according to claim 1 wherein the controller (32) has means for activating an audible alarm (38) or visible alarm (39) in the event that a signal from the monitoring means (35) indicates that the coupling (20) is slipping or disengaged.

8. The actuator system according to claim 1 wherein the controller (32) is configured to control several linear actuators (31), which in parallel perform the same adjustment function, and in the event that a coupling (20) of any of the linear actuators (31) is slipping or disengaged, all parallelly connected linear actuators (31) will be set to the inactive state.

9. The actuator system according to claim 4 wherein the controller (32) has programmable means (36) configured to calculate the relative movement of the spindle nut (12) based on the input from the Hall sensor (44b) and store the latest calculated position of the spindle nut (12) in case a signal from the monitoring means (35) indicates that the coupling (20) is slipping or disengaged.

10. The actuator system according to claim 1 further comprising a user control unit (40) with an input button (41) configured to providing signals corresponding to a command for the input (33) of the controller (32) wherein the controller (32) is configured to block the re-activation of the electric actuator (31) when a signal from the monitoring means (35) indicates that the coupling (20) is slipping or disengaged, until the operator has released and subsequently reactivated the input button (40) and/or after a predetermined safety time has elapsed.

11. The actuator system according to claim 1 wherein the coupling (20) is a ratchet coupling, where the coupling (20) in one driving direction is configured to be in a state of engaged and where the coupling (20) in the opposite driving direction is configured to be either in the state of engaged or slipping or disengaged.
